(19) United States
(12) Patent Application Publication
(10) Pub. No.: US 2021/0264395 A1
(43) Pub. Date: Aug. 26, 2021

(54) AUTOMATED SALE DEVICE THAT USES BIOMETRICS

(71) Applicant: Alclear, LLC, New York, NY (US)

(72) Inventors: Joe Trelin, New York, NY (US); Matthew Snyder, New York, NY (US)

(21) Appl. No.: 17/319,674

(22) Filed: May 13, 2021

Related U.S. Application Data
(63) Continuation of application No. 16/160,261, filed on Oct. 15, 2018.

(51) Int. Cl. G06Q 20/18; G06Q 20/20; G06Q 20/40

(52) U.S. Cl. CPC G06Q 20/18; G06Q 20/206; G06Q 20/40145; G06Q 20/202

(57) ABSTRACT

An automated sale system that uses biometrics obtains biometric data of a person received using an automated sale device. The automated sale device may be an alcohol automated sale device. Age and sobriety are determined using the biometric data and/or an identity determined using the biometric data. When age and sobriety requirements are satisfied, vending is allowed. In some implementations, sobriety is evaluated only if age requirements are satisfied. In other implementations, age is evaluated only if sobriety requirements are satisfied. In numerous implementations, sobriety and identity are evaluated using data obtained from a single biometric reading.

### CROSS-REFERENCE FOR RELATED APPLICATION(S)

This application is a continuation patent application of U.S. patent application Ser. No. 16/160,261, filed Oct. 15, 2018 and titled “Automated Sale Device that Uses Biometrics,” the disclosure of which is hereby incorporated herein by reference in its entirety.

### FIELD

The described embodiments relate generally to automated sale devices. More particularly, the present embodiments relate to automated sale systems that determine identity.

### BACKGROUND

Vending machines typically provide goods or services in exchange for payment. By automating transactions, vending machines may process transactions more efficiently using fewer resources than human operated transaction arrangements. Vending machines are often used to sell soft drinks, candy, and other food items.

Use of vending machines may provide a seller less control than human operated transaction arrangements. Due to the configuration of the automated mechanisms, sellers may only have so much control over what is sold, how it is sold, how payments are accepted, and how security is maintained.

### SUMMARY

The present disclosure relates to automated sale devices that use biometrics. Automated sale devices that use biometrics may be used in systems that determine identity and provide one or more attestations that are used to control vending. Such attestations may link biometrics and sobriety determinations, such as in systems where automated sale devices are used to vend alcohol or prescription medications. In some implementations, such automated sale devices may be used in systems that configure operations in real time according to applicable legal requirements. These various technologies allow automated sale devices and/or the systems in which they operate to perform functions not previously possible as well as to function more efficiently using fewer resources.

In various embodiments, an automated sale system that uses biometrics includes at least one non-transitory storage medium that stores instructions and at least one processor. The at least one processor executes the instructions to obtain biometric data of a person received using an automated sale device; when the person is determined to be sober, determine an identity of the person using the biometric data; determine an age of the person using the identity; and when the age of the person meets an age threshold, enable vending via the automated sale device.

In some examples, the at least one processor determines whether the person is sober using the biometric data. In various examples, the at least one processor disables the vending via the automated sale device when the person is determined to not be sober. In other examples, the automated sale device determines whether the person is sober.

In numerous examples, the at least one processor determines payment information associated with the identity for a transaction corresponding to the vending and enables the vending via the automated sale device after processing the transaction using the payment information. In some such examples, the at least one processor determines the payment information associated with the identity by determining the identity lacks associated payment information, using the identity to establish a credit account, associating the credit account with the identity, and using the credit account to process the transaction. In various examples, the automated sale device performs the vending after processing a payment for a transaction corresponding to the vending.

In some embodiments, an automated sale system that uses biometrics includes at least one non-transitory storage medium that stores instructions and at least one processor. The at least one processor executes the instructions to obtain biometric data of a person received using an automated sale device; determine an identity of the person using the biometric data; determine an age of the person using the identity; when the age of the person meets an age threshold, determine a sobriety of the person; and when the sobriety indicates the person is sober, enable vending.

In various examples, the at least one processor determines the sobriety of the person using a same biometric data used to determine the identity. In some such examples, the biometric data may be at least one image of at least a portion of a face. In other such examples, the biometric data may be an optical scan of a finger.

In numerous examples, the at least one processor determines the identity using first biometric data and determines the sobriety of the person using second biometric data that is different than the first biometric data. In some such examples, the first biometric data may be a phosphoresce image of a print of a finger and the second biometric data may be an optical scan of the finger.

In various examples, the at least one processor determines the sobriety of the person using a threshold number of failed attempts to provide the biometric data.

In numerous embodiments, an automated sale system that uses biometrics includes at least one non-transitory storage medium that stores instructions and at least one processor. The at least one processor executes the instructions to obtain biometric data of a person received using an automated sale device; determine a sobriety of the person using the biometric data; determine an identity of the person using the biometric data; determine an age of the person using the identity; and when the age of the person meets an age threshold and the sobriety indicates the person is sober, enable vending via the automated sale device.

In some examples, the automated sale device vends alcohol. In various examples, the at least one processor determines the sobriety of the person using a previous intoxication determination made within a threshold period of time. In numerous examples, the at least one processor determines the sobriety of the person using a determination of previous alcohol purchases associated with the identity made within a threshold period of time via one or more automated sale devices.

In various examples, the at least one processor disables the vending upon determining that the identity is unauthorized to use the automated sale device. In some such examples, the identity is unauthorized to use the automated sale device due to previous misuse of one or more automated sale devices.

### BRIEF DESCRIPTION OF THE DRAWINGS

The disclosure will be readily understood by the following detailed description in conjunction with the accompanying drawings, wherein like reference numerals designate like structural elements.

FIG. 1 depicts a first example identity attestation system.

FIG. 2 depicts a flowchart illustrating an example method for operating an identity attestation system. The example method may be performed by the example identity attestation system of FIG. 1.

FIG. 3 depicts example components and example functional relationships among components that may be used to implement the example identity attestation system of FIG. 1.

FIG. 4 depicts a second example identity attestation system that may link identity and sobriety.

FIG. 5 depicts a flowchart illustrating a first example method for operating an identity attestation system that links identity and sobriety. The example method may be performed by one or more of the example identity attestation systems of FIGS. 1 and 4.

FIG. 6 depicts a flowchart illustrating a second example method for operating an identity attestation system that links identity and sobriety. The example method may be performed by the example identity attestation systems of FIGS. 1 and 4.

FIG. 7 depicts a flowchart illustrating a third example method for operating an identity attestation system that links identity and sobriety. The example method may be performed by the example identity attestation systems of FIGS. 1 and 4.

FIG. 8 depicts a flowchart illustrating an example method for operating an identity attestation system that provides age attestations. The example method may be performed by the example identity attestation systems of FIGS. 1 and 4.

FIG. 9 depicts a flowchart illustrating an example method for operating an identity attestation system that provides age and payment attestations. The example method may be performed by the example identity attestation systems of FIGS. 1 and 4.

FIG. 10 depicts a flowchart illustrating an example method for operating an identity attestation system that provides age, sobriety, and payment attestations. The example method may be performed by the example identity attestation systems of FIGS. 1 and 4.

FIG. 11 depicts a flowchart illustrating an example method for operating an identity attestation system that provides age, sobriety, authorization, and payment attestations. The example method may be performed by the example identity attestation systems of FIGS. 1 and 4.

FIG. 12 depicts a flowchart illustrating an example method for operating an identity attestation system that determines and provides a variable number of attestations. The example method may be performed by the example identity attestation systems of FIGS. 1 and 4.

FIG. 13 depicts a flowchart illustrating an example method for operating an identity attestation system that processes payments. The example method may be performed by the example identity attestation systems of FIGS. 1 and 4.

FIG. 14 depicts a flowchart illustrating an example method for operating an identity attestation system that configures decision points using real time obtained legal requirements. The example method may be performed by the example identity attestation systems of FIGS. 1 and 4.

FIG. 15 depicts a flowchart illustrating an example method for operating an identity attestation system that configures data storage relating to identity using real time obtained legal requirements. The example method may be performed by the example identity attestation systems of FIGS. 1 and 4.

FIG. 16 depicts a flowchart illustrating an example method for operating an identity attestation system that configures an age attestation decision point using real time obtained legal requirements. The example method may be performed by the example identity attestation systems of FIGS. 1 and 4.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems, apparatuses, methods, and computer program products that embody various elements of the present disclosure. However, it should be understood that the described disclosure may be practiced in a variety of forms in addition to those described herein.

The following disclosure relates to automated sale devices that use biometrics. Automated sale devices may be used in systems that determine identity and provide one or more attestations that are used to control vending. Such attestations may link biometrics and sobriety determinations, such as in systems where automated sale devices are used to vend alcohol or prescription medications. In some implementations, such automated sale devices may be used in systems that configure operations in real time according to applicable legal requirements. These various technologies allow automated sale devices and/or the systems in which they operate to perform functions not previously possible as well as to function more efficiently using fewer resources.

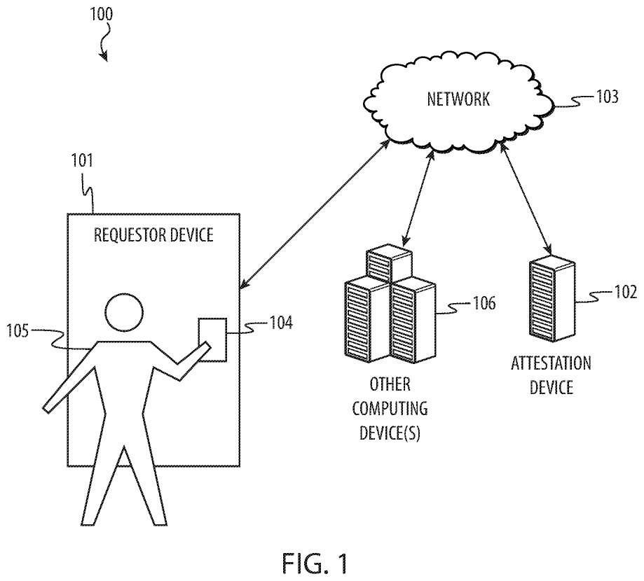

These and other embodiments are discussed below with reference to FIGS. 1-16. However, those skilled in the art will readily appreciate that the detailed description given herein with respect to these Figures is for explanatory purposes only and should not be construed as limiting.

FIG. 1 depicts a first example identity attestation system 100. The identity attestation system 100 may include one or more requestor devices 101 and one or more attestation devices 102. The requestor device 101 may communicate with the attestation device 102 via one or more communication networks 103 in order to obtain one or more attestations regarding the identity of one or more persons 105. The attestation device 102 and/or the requestor device 101 may also communicate with one or more other computing devices 106 as part of the attestation device 102 providing one or more attestations to the requestor device 101.

For example, the attestation device 102 may be one or more computing devices of a biometric identification system that stores biometric information correlated with authenticated identities of people. The attestation device 102 may receive one or more digital representations (such as a digitization, an image, a hash, and so on) of biometrics (such as a fingerprint, an iris scan, a facial image, a gait, a deoxyribonucleic acid sample, a saliva sample, a retina scan, and/or any other biometric information of a person) or other biometric data obtained via one or more biometric readers 104 (such as a camera, fingerprint scanner, and/or any other kind of device that is operable to obtain biometric information) of the requestor device 101. The attestation device 102 may compare the received digital representation of the biometric to the stored biometric information, determine an identity of a person associated with the stored biometric information using the comparison, and provide one or more attestations associated with the determined identity. This may allow enrollment in the biometric identification system to be performed separately from the requestor device 101, used for various requestor devices 101, and/or free the requestor device 101 from needing to store such information (though such information may be cached at the requestor device 101 in some examples, such as implementations where the requestor device 101 is an automated sale device, such as a vending machine, at a sporting arena and is preloaded with information regarding ticket holders so as to enable operation if the communication network 103 becomes unavailable).

By way of illustration, such attestations may include attesting to the identity of the person, attesting to an age associated with the identity or that the age at least meets a threshold, attesting that a payment has been processed associated with the identity, attesting to whether or not the identity is associated with a white or black list in a criminal or other database, attestation regarding a sobriety or intoxication level (such as a blood alcohol level, a drug intoxication level, and/or any other sobriety or intoxication level) associated with the identity, attesting to association of the identity with a rewards program, and/or any other kind of attestation that may be made associated with the determined identity.

The attestation device 102 and/or the requestor device 101 may communicate with one or more other computing devices 106 as part of determining the identity and/or providing the attestations. For example, the computing device 106 may include a biographic information database, a criminal database, an age verification system, a payment processing system, a legal database storing legal requirements (such as statutes, regulations, laws, and so on) relating to operations of the requestor device 101 and/or the attestation device 102, and/or any other computing device that the attestation device 102 and/or the requestor device 101 may communicate with as part of determining the identity and/or providing the attestations.

In some implementations, the attestation device 102 may be configured to provide a specific set of attestations. For example, the attestation device 102 may be configured to provide attestations regarding whether or not an age threshold is met, whether or not the person is sober, and whether or not payment has been processed for a transaction.

In other implementations, the attestation device 102 may be configured to provide different sets of attestations for different requestor devices 101. For example, the attestation device 102 may determine whether the requestor device 101 is a first requestor device 101 or a second requestor device 101 (such as using a transmitted identifier, a communication network 103 that a request is transmitted though, and so on). The attestation device 102 may provide attestations regarding whether or not a transaction is authorized and payment has been processed if the request is received from the first requestor device 101. However, the attestation device 102 may provide attestations regarding whether or not a person is sober, whether or not a person is at least twenty-one years of age, and whether or not payment has been processed if the request is received from the second requestor device 101. In this way, a single attestation device 102 may be configurable to provide a wide variety of different attestations for a number of different requestor devices 101.

This may allow the identity attestation system 100 to function faster and more efficiently and flexibly while using fewer resources as compared to systems that would use different attestation devices 102 for each requestor device 101 that had a different set of attestation requirements. Further, this would also allow changes without requiring design and construction of an entirely different identity attestation system 100 each time attestation requirements or procedures changed.

In yet other implementations, requestor devices 101 may submit a data structure. Such a data structure may include one or more digital representations of biometrics, descriptions of the digital representations of the biometrics and/or instructions regarding processing of the digital representations of the biometrics, requestor device 101 identifiers, requested attestations, specifications of transaction details related to a request, and so on. This may allow the attestation device 102 to use a single format for data structures relating to a variety of different requests received from a number of different requestor devices 101. The attestation device 102 may thus be configured to process a single data structure while supporting various attestation requests as indicated in the data structure. The attestation device 102 may be a pay service and requestor devices 101 may be able to pick which attestations to request and pay for by specifying such in the data structure. This may further allow the identity attestation system 100 to function faster and more efficiently and flexibly while using fewer resources due to the flexibility provided by configuring attestation processes according to specifications in a single data structure.

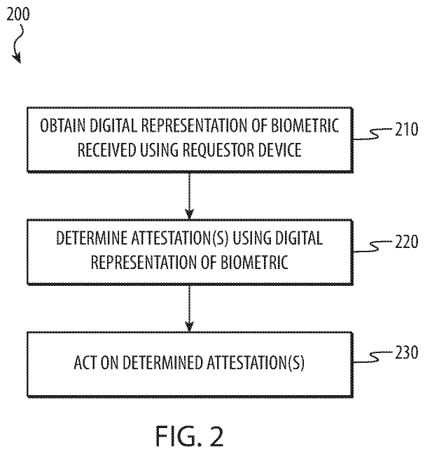

FIG. 2 depicts a flowchart illustrating an example method 200 for operating an identity attestation system. The example method 200 may be performed by the example identity attestation system 100 of FIG. 1.

At 210, a computing device may obtain a digital representation of at least one biometric received using a requestor device. In some examples, the computing device may be the attestation device 102 of FIG. 1.

At 220, the computing device determines one or more attestations using the digital representation of the biometric. For example, the computing device may use the digital representation of the biometric to determine an identity of a person and then provide one or more attestations using that identity. Such attestations may include an age verification, a sobriety verification, a payment verification, and/or any other kind of attestation that may be associated with the identity.

At 230, the computing device acts on the attestations. For example, the computing device may provide the attestations to a requestor device. By way of another example, the computing device may signal a device other than a requestor device when an attestation is made or based on a condition the computing device determined occurred while determining the attestations.

For example, a computing device may provide an attestation that a payment has been processed for a beverage at a sporting arena. The computing device may determine that an identity associated with the payment belongs to a rewards program. The rewards program may qualify the identity for a free or reduced price food product because of the beverage purchase. As such, the computing device may transmit a notification to a mobile computing device (such as a mobile phone) associated with the identity. The notification may include information regarding the free or reduced price food product and how the free or reduced price food product may be claimed.

In various examples, this example method 200 may be implemented as a group of interrelated software modules or components that perform various functions discussed herein. These software modules or components may be executed by one or more computing devices, such as one or more of the requestor device 101, the attestation device 102, and/or the other computing device 106 of FIG. 1.

Although the example method 200 is illustrated and described as including particular operations performed in a particular order, it is understood that this is an example. In various implementations, various orders of the same, similar, and/or different operations may be performed without departing from the scope of the present disclosure.

For example, the example method 200 is illustrated and described as being performed by a computing device like the attestation device 102 of FIG. 1. However, in other implementations, the method 200 may be performed by a device such as the requestor device 101 of FIG. 1. In such an implementation, the requestor device 101 may obtain a digital representation of a biometric or other biometric data, determine attestations by transmitting the digital representation of the biometric to an attestation device 102 and receiving the attestations in return, and then act upon the received attestations. For example, the requestor device 101 may be an automated sale device that vends depending on the attestations received from the attestation device 102. Various configurations are possible and contemplated without departing from the scope of the present disclosure.

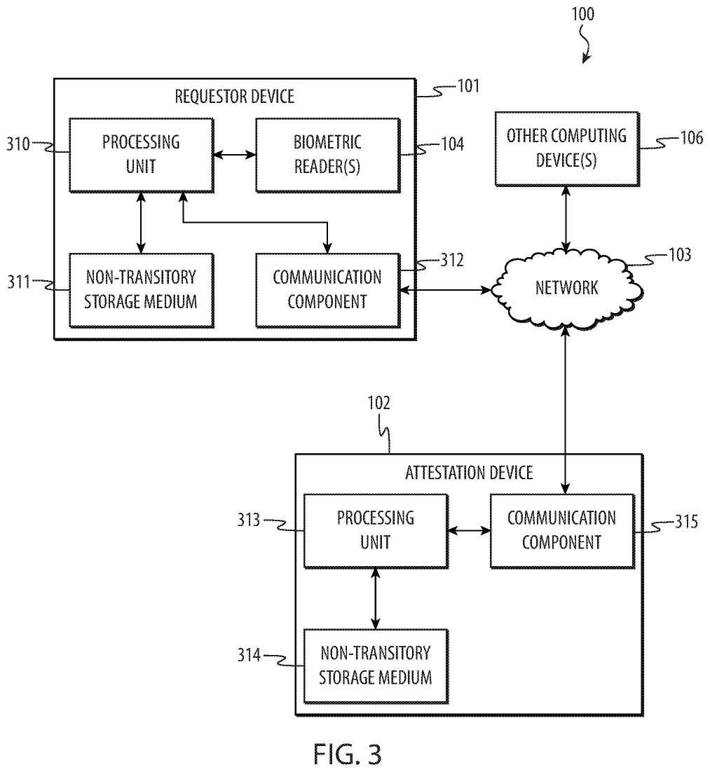

FIG. 3 depicts example components and example functional relationships among components that may be used to implement the example identity attestation system 100 of FIG. 1. As illustrated, one or more communications networks 103 may communicably interconnect one or more requestor devices 101, attestation devices 102, and/or other computing devices 106.

The requestor device 101 may be one or more computing devices (such as a desktop computing device, a laptop computing device, a biometric or other vending machine, an automated sale device, a mobile computing device, a tablet computing device, a smart phone, a digital media player, and so on) that includes one or more processing units 310 or other processors or controllers, one or more non-transitory storage media 311, one or more biometric readers 104 (which may be any kind of device that may be used to obtain a biometric, such as one or more integrated and/or external still image or video cameras, fingerprint readers, microphones, and so on), one or more communication components 312, and/or various other components. The processing unit 310 may execute one or more instructions stored in the storage medium 311 to perform various requestor device 101 functions. For example, the processing unit 310 may communicate with the attestation device 102 using the communication component 312.

Similarly, the attestation device 102 may be one or more computing devices that include one or more processing units 313, non-transitory storage media 314, and/or communication components 315. The processing unit 313 may execute one or more instructions stored in the storage medium 314 to perform various attestation device 102 functions. For example, the processing unit 313 may perform a method for operating an identity attestation system, such as the first example method 200.

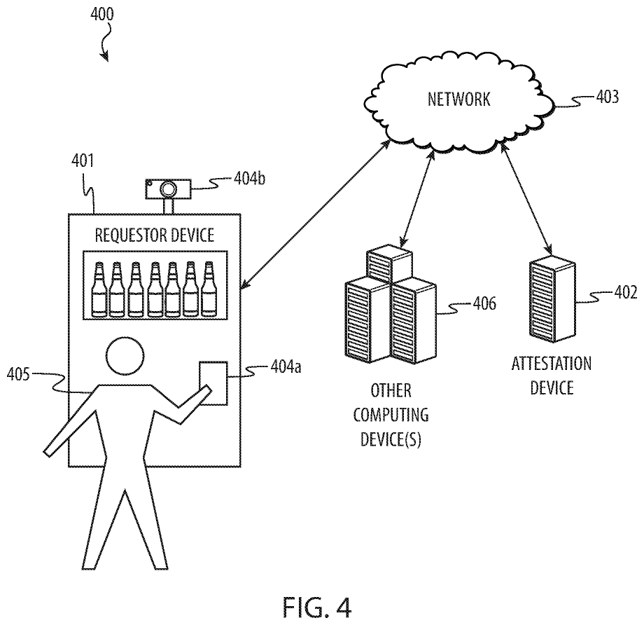

FIG. 4 depicts a second example identity attestation system 400 that may link identity and sobriety. The identity attestation system 400 may include an attestation device 402 that may be operable to communicate with one or more requestor devices 401 and/or one or more other computing devices 406 via a communication network 403. The attestation device 402 may be operable to determine identity and/or sobriety of a person 405, link determined identity and sobriety, and/or provide one or more attestations associated with the determined identity and/or sobriety.

For example, the requestor device 401 may be an automated sale device (such as an alcohol vending machine, a pharmacy vending machine, and so on). The requestor device 401 may request one or more attestations from the attestation device 402 regarding whether or not to vend for a person. The attestation device 402 may determine a sobriety and/or identity for the request and provide one or more attestations based thereon. The requestor device 401 may then vend or not depending on the identity and/or sobriety attestations.

For example, an automated sale device may be configured to vend alcohol. The automated sale device may obtain a digital representation of a biometric or other biometric data for the person when the person requests alcohol. An identity and sobriety may be determined for the person. The identity may be used to determine if the person is of age to buy alcohol. If so, the sobriety may be used to determine if alcohol can be sold to the person. If so, payment information associated with the identity may be used to process payment before alcohol is vended. In some examples, the automated sale device may itself process payment information, such as in implementations where the automated sale device includes a credit card reader, a cash collection mechanism, and so on.

It is understood that this is an example. In other examples, sobriety may be determined prior to age verification. In yet other examples, payment information may not be associated with the identity. If the identity lacks associated payment information, biographic information associated with the identity may be used to create a credit or other payment account that may then be used to process payment. Various configurations are possible and contemplated without departing from the scope of the present disclosure.

As discussed above, the identity attestation system 400 may link identity and sobriety. By way of illustration, the requestor device 401 may obtain a digital representation of a biometric or other biometric data using a biometric reader 404a. The attestation device 402 may be operable to determine an identity and a sobriety using the digital representation of the biometric. For example, the biometric reader 404a may use a light source to capture an image of a fingerprint as well as a measurement of blood flowing through the finger by monitoring how much of emitted light is reflected back from the finger and/or absorbed by the finger. The image of the fingerprint may be used to determine identity while the measurement of the blood flow may be used to determine a pulse rate that is correlated to a sobriety determination. As such, a single biometric reading may be used to determine both identity and sobriety. Although this example is described as the attestation device determining sobriety, in some examples sobriety may be determined by the requestor device 401.

In another example, the biometric reader 404a may be a phosphorescence sensor that uses phosphorescence to create a light representation of a fingerprint. The biometric reader 404a may also include electrical contacts that touch the finger being captured. Electrical current passed through the finger via the electrical contacts may be used to measure the electrical resistance of chemicals in the person's sweat or body water. This electrical resistance may be used to determine an alcohol and/or other chemical level in the person's blood to determine sobriety or intoxication level.

In yet another example, the biometric reader 404a may include both a phosphorescence sensor that obtains a light representation of a fingerprint as discussed above and an optical sensor that transmits light and measures light reflected back from the body to determine blood flow. The sensors may be stacked, such as where the phosphorescence sensor is above the optical sensor or the reverse, may be positioned at different regions of the same surface, and so on.

In other examples, the biometric reader 404a may be a camera that obtains images of a person's eye, face, iris, retina, gait, and so on. These images may be used to identify the person and may also be analyzed to determine sobriety. For example, facial tracking may be used to determine that a person is intoxicated. By way of another example, pupil dilatation may be analyzed to determine sobriety.

In yet other examples, the requestor device 401 may include an additional biometric reader 404b (such as one or more cameras, breathalyzer devices, and so on). In such examples, identity may be determined using one or more biometrics obtained using the biometric reader 404a while sobriety may be determined using data from the additional biometric reader 404b. By way of illustration, the biometric reader 404a may be a phosphorescence sensor that obtains a light representation of a fingerprint while the additional biometric reader 404b may be a camera that tracks body movement. The light representation of the fingerprint may be used to determine identity whereas the body movement may be analyzed to determine sobriety.

In still other examples, sobriety may be otherwise determined using identity. By way of illustration, a determination of intoxication may have been previously made within a time period (such as eight hours) and associated with an identity. Subsequently, sobriety may be determined by identifying the previous intoxication determination associated with the identity. By way of another illustration, sobriety may be determined by tracking the number of times it takes a person to biometrically identify himself. If the person repeatedly has issues placing their finger on a fingerprint reader, the cause may be that the person is too intoxicated to perform the task correctly.

Although FIG. 4 is illustrated and described in the context of an alcohol automated sale device, it is understood that this is an example. In other implementations, various other automated sale devices, vending machines, and/or other automated dispensing devices that may and/or may not evaluate sobriety are possible and contemplated without departing from the scope of the present disclosure.

By way of illustration, an automated sale device, such as a vending machine, may be configured to dispense prescription and/or nonprescription pharmacy products. For example, an automated pharmacy vending machine may be operable to dispense medical products the amount of purchase of which is restricted within a period of time, such as medicines containing pseudoephedrine or related compounds. In such examples, the automated pharmacy vending machine may determine an identity for a person (such as using a digital representation of a biometric, a social media account, and so on) and determine whether information associated with the identity indicates the person has not yet purchased the regulated threshold amount prior to dispensing. In some cases of such examples, such medicine may also be restricted by age and the automated pharmacy vending machine may use the information associated with the identity to verify the person is of sufficient age to purchase the medicine as well as one or more other functions, such as payment.

In other examples, such automated pharmacy vending machines may be operable to communicate with one or more insurance databases. For example, the automated pharmacy vending machine may use information associated with a determined identity to determine whether or not a person has insurance coverage that would pay for and/or discount a prescription and/or nonprescription product purchase. If so, the automated pharmacy vending machine may use the information and/or the insurance database to at least partially process payment for the product prior to dispensing.

In still other examples, the automated pharmacy vending machine may communicate with one or more databases associated with a manufacturer of the product to see if the identity qualifies for any free and/or discounted pricing. For example, some prescription medication manufacturers may offer discounted pricing if a person does not have medication insurance coverage and has an income less than a threshold (such as an income of less than $20,000 per year, income from only social security, and so on). If so, the automated pharmacy vending machine may use the information and/or the product manufacturer database to at least partially process payment for the product prior to dispensing. In other examples, the database may be an assistance program other than one operated by a manufacturer of the product, such as a governmental assistance program, a charity organization, and so on. Various configurations are possible and contemplated without departing from the scope of the present disclosure.

Although the above illustrates and describes performing actions using the identity determined to be associated with a person obtaining a product from an automated sale device, such as a vending machine, it is understood that this is an example. In various implementations, an identity may be determined for a person attempting to authorize a vending machine or other electronic device to dispense to another person.

For example, a doctor may provide a digital representation of a biometric (and/or other item or information) to a device or system (such as a prescription entry system including a biometric reader located at the doctor's office) to authorize a prescription for a patient. An identity for the doctor may be determined using the provided digital representation of the biometric. If information for the identity allows the doctor to authorize the prescription for the patient, the prescription may be authorized. The prescription may be provided to an automated pharmacy vending machine that the patient can use to obtain medication associated with the prescription. Various configurations are possible and contemplated without departing from the scope of the present disclosure.

In yet other examples, automated sale devices of various types may communicate with a variety of different databases using information associated with a determined identity as part of processing payment. For example, products may be paid and/or discounted as part of a rewards, loyalty, or other program. In other examples, rewards points unassociated with the actual product (such as credit card rewards points, airline miles, and so on) may be used to pay for and/or discount the product. Various configurations are possible and contemplated without departing from the scope of the present disclosure.

In various examples, automated sale devices may be configured to dispense one or more different age-restricted and/or other controlled access products. Such products may include alcohol, weapons, lottery tickets and/or other gambling-related products, tobacco and/or other nicotine and/or nicotine-related products (such as cigarette papers, tobacco pipes, electronic cigarette cartridges, and so on), spray paint, and/or any other product the dispensing of which may be restricted based on age. In such examples, the automated sale device may determine an identity for a person (such as using a digital representation of a biometric, a social media account, and so on) and determine whether information associated with the identity indicates the automated sale device may dispense one or more age-restricted and/or other controlled access products to the person. The automated sale device may also use the information associated with the identity to obtain payment for the product and/or for a variety of other functions discussed in other embodiments disclosed herein. Various configurations are possible and contemplated without departing from the scope of the present disclosure.

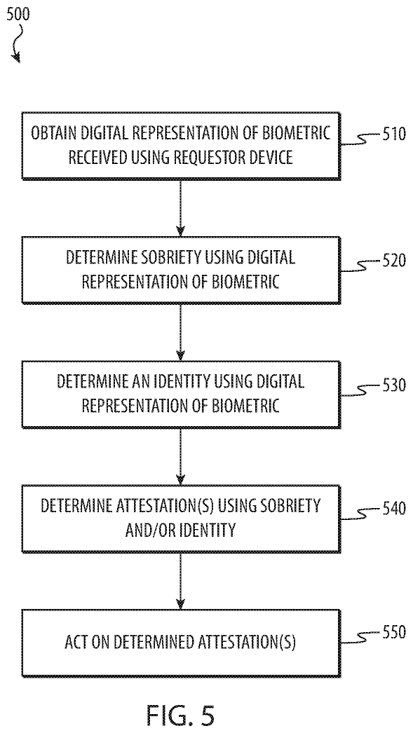

FIG. 5 depicts a flowchart illustrating a first example method 500 for operating an identity attestation system that links identity and sobriety. The example method 500 may be performed by one or more of the example identity attestation systems 100, 400 of FIGS. 1 and 4.

At 510, an electronic device obtains a digital representation of a biometric or other biometric data received using a requestor device. At 520, the electronic device determines a sobriety using the digital representation of the biometric.

In some examples, the digital representation of the biometric may itself be analyzed to determine sobriety. For example, the digital representation of the biometric may be a facial image that is analyzed to determine if a person exhibits symptoms of intoxication (such as dilated pupils, staggering, and so on). By way of another example, the digital representation of the biometric may be used to determine an identity and the identity may then be used to determine a sobriety, such as where an intoxication determination has been recently made and associated with the identity.

At 530, the electronic device determines an identity using the digital representation of the biometric. At 540, the electronic device determines one or more attestations using the sobriety and/or identity. For example, the attestations may include an attestation that the person is sober, is of age to buy alcohol, and has paid for an alcohol purchase.

At 550, the electronic device acts based on the determined attestations. The act may be providing the attestations to a requestor device, instructing an automated sale device to vend, preventing an automated sale device from vending, disabling an automated sale device, vending, and/or various other actions.

In various examples, this example method 500 may be implemented as a group of interrelated software modules or components that perform various functions discussed herein. These software modules or components may be executed by one or more computing devices, such as one or more of the requestor devices 101, 401; the attestation devices 102, 402; and/or the other computing devices 106, 406 of FIGS. 1 and 4.

Although the example method 500 is illustrated and described as including particular operations performed in a particular order, it is understood that this is an example. In various implementations, various orders of the same, similar, and/or different operations may be performed without departing from the scope of the present disclosure.

For example, the method 500 is illustrated and described as determining sobriety and then identity. However, in various implementations, these operations may be reversed or combined. For example, as described above, sobriety may be determined using the identity. In such an example, identity may be determined before and/or as part of determining sobriety. Various configurations are possible and contemplated without departing from the scope of the present disclosure.

In some examples, an identity may be prohibited from purchasing alcohol from an alcoholic automated sale device for reasons other than age or sobriety. For example, an identity may be listed on an alcohol purchase blacklist at sporting events due to previous infractions for providing purchased alcohol to minors or other alcohol restrictions or violations. By way of another example, an identity may be flagged for previous misuse of the alcoholic automated sale device, such as use of the alcoholic automated sale device to provide alcohol to minors. In other examples, an identity may be associated with a more than a threshold number of alcohol purchases in a period of time and may be prohibited from purchasing more. In yet other examples, monitoring using a camera or other device may indicate that a person associated with the identity is likely to provide the alcohol to a minor. Various configurations are possible and contemplated without departing from the scope of the present disclosure.

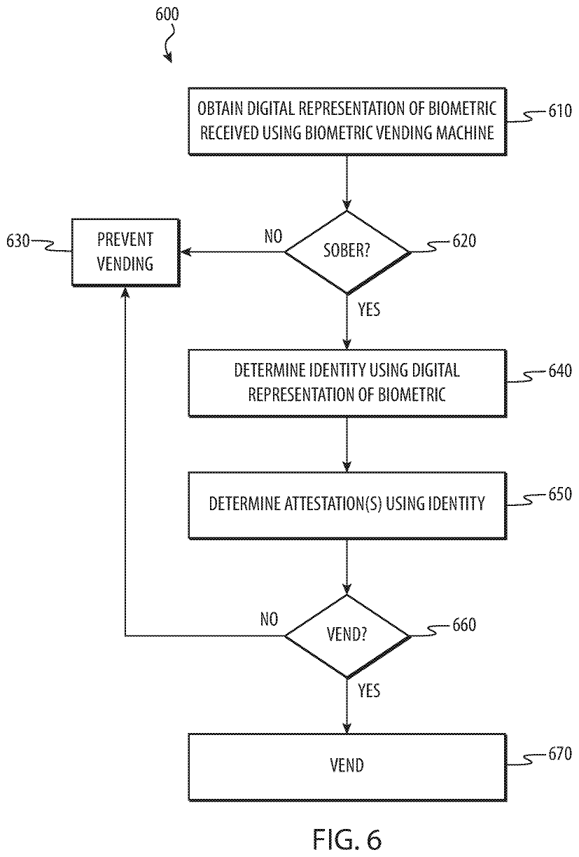

FIG. 6 depicts a flowchart illustrating a second example method 600 for operating an identity attestation system that links identity and sobriety. The example method 600 may be performed by one or more of the example identity attestation systems 100, 400 of FIGS. 1 and 4.

At 610, one or more electronic devices may obtain a digital representation of a biometric or other biometric data received using automated sale devices, such as a biometric vending machine. At 620, the electronic device may determine whether or not a person associated with the digital representation of the biometric is sober. If not, the flow may proceed to 630 where the electronic device prevents vending (such as by instructing a vending machine not to vend, determining itself not to vend in implementations where the electronic device is the biometric vending machine, and so on). Otherwise, the flow proceeds to 640.

At 640, after the electronic device determines the person is sober, the electronic device determines an identity associated with the digital representation of the biometric. The flow then proceeds to 650 where the electronic device determines one or more attestations using the identity. Such attestations may include sobriety, age verification, authorization to purchase, payment processing, payment confirmation, and so on.

At 660, the electronic device determines whether or not vending should be allowed. If so, the flow proceeds to 670 where vending is authorized (such as by instructing a vending machine to vend, determining itself to vend in implementations where the electronic device is the biometric vending machine, and so on). Otherwise, the flow proceeds to 630 where vending is prevented.

In various examples, this example method 600 may be implemented as a group of interrelated software modules or components that perform various functions discussed herein. These software modules or components may be executed by one or more computing devices, such as one or more of the requestor devices 101, 401; the attestation devices 102, 402; and/or the other computing devices 106, 406 of FIGS. 1 and 4.

Although the example method 600 is illustrated and described as including particular operations performed in a particular order, it is understood that this is an example. In various implementations, various orders of the same, similar, and/or different operations may be performed without departing from the scope of the present disclosure.

For example, 660 illustrates and describes the electronic device determining whether or not to vend. However, it is understood that this is an example. In other implementations, the electronic device may provide the attestations that another electronic device uses to determine whether or not to vend. Various configurations are possible and contemplated without departing from the scope of the present disclosure.

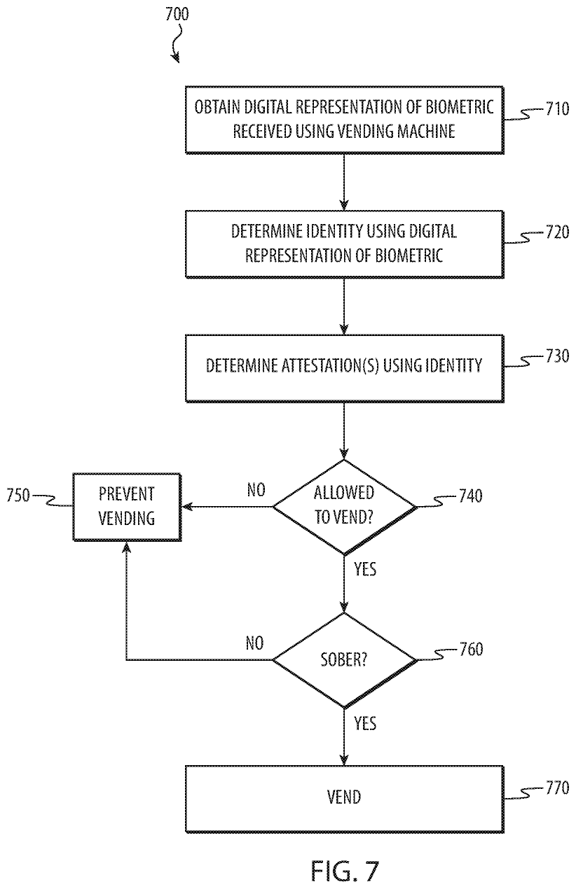

FIG. 7 depicts a flowchart illustrating a third example method 700 for operating an identity attestation system that links identity and sobriety. The example method 700 may be performed by one or more of the example identity attestation systems 100, 400 of FIGS. 1 and 4.

At 710, an electronic device obtains a digital representation of a biometric or other biometric data received using an automated sale device, such as a vending machine. At 720, the electronic device determines an identity using the digital representation of the biometric. At 730, the electronic device determines one or more attestations using the identity. At 740, the electronic device determines whether or not to allow vending using the identity. If not, the flow proceeds to 750 where the electronic device prevents vending. Otherwise, the flow proceeds to 760.

At 760, the electronic device determines whether or not a person associated with the identity is sober. The electronic device may determine sobriety or intoxication level using the identity, the digital representation of the biometric, one or more other biometrics, and so on. If not, the flow proceeds to 750 where the electronic device prevents vending. Otherwise, the flow proceeds to 770 where the electronic device determines to allow vending.

In various examples, this example method 700 may be implemented as a group of interrelated software modules or components that perform various functions discussed herein. These software modules or components may be executed by one or more computing devices, such as one or more of the requestor devices 101, 401; the attestation devices 102, 402; and/or the other computing devices 106, 406 of FIGS. 1 and 4.

Although the example method 700 is illustrated and described as including particular operations performed in a particular order, it is understood that this is an example. In various implementations, various orders of the same, similar, and/or different operations may be performed without departing from the scope of the present disclosure.

For example, in some implementations the electronic device may not evaluate sobriety. Instead, the electronic device may determine other authorizations. For example, the vending machine may be an automated pharmacy. In such an example, the electronic device may determine whether or not the person has a valid prescription before vending medication associated with the prescription. Various configurations are possible and contemplated without departing from the scope of the present disclosure.

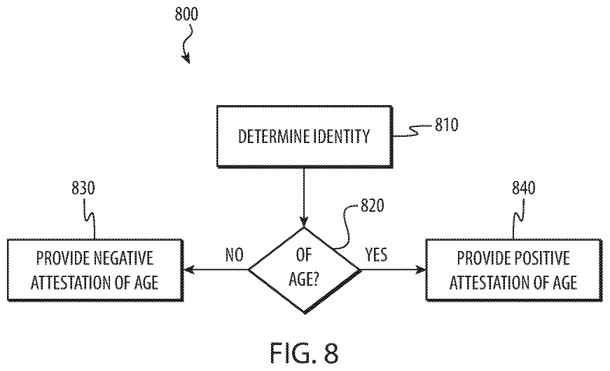

FIG. 8 depicts a flowchart illustrating an example method 800 for operating an identity attestation system that provides age attestations. The example method 800 may be performed by one or more of the example identity attestation systems 100, 400 of FIGS. 1 and 4.

At 810, an electronic device determines an identity. In some implementations, the electronic device may determine an identity by comparing a received digital representation of a biometric or other biometric data with stored biometric information associated with one or more authenticated identities. The flow then proceeds to 820 where the electronic device uses the identity to determine whether or not the person is of age (such as eighteen for tobacco purchases, twenty-one for alcohol purchases, eighteen for voting, and/or any other age threshold that may be used in an identity attestation system).

For example, age information may be stored in information associated with the identity. In other examples, an age verification database may be accessed using biographic information stored in association with the identity. Various configurations are possible and contemplated.

If the electronic device determines the person is of age, the flow may proceed to 840 where the electronic device provides a positive attestation of age. Otherwise, the flow may proceed to 830 where the electronic device provides a negative attestation of age.

In various examples, this example method 800 may be implemented as a group of interrelated software modules or components that perform various functions discussed herein. These software modules or components may be executed by one or more computing devices, such as one or more of the requestor devices 101, 401; the attestation devices 102, 402; and/or the other computing devices 106, 406 of FIGS. 1 and 4.

Although the example method 800 is illustrated and described as including particular operations performed in a particular order, it is understood that this is an example. In various implementations, various orders of the same, similar, and/or different operations may be performed without departing from the scope of the present disclosure.

For example, the method 800 is illustrated and described as providing positive or negative attestations of age. However, in various examples, the electronic device may instead provide the age, provide only a positive or a negative attestation of age or not, and so on. Various configurations are possible and contemplated without departing from the scope of the present disclosure.

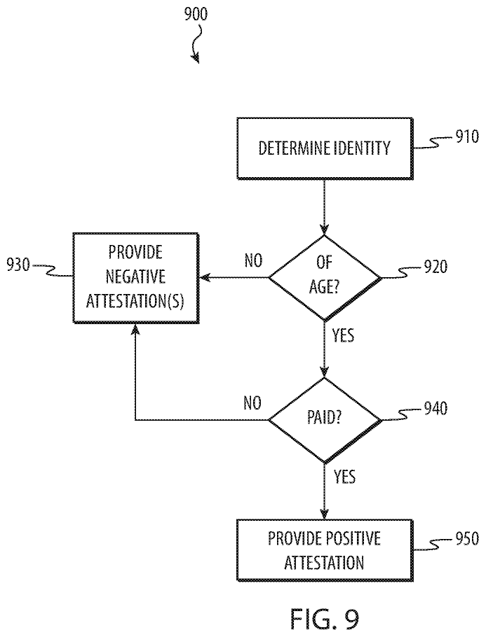

FIG. 9 depicts a flowchart illustrating an example method 900 for operating an identity attestation system that provides age and payment attestations. The example method 900 may be performed by one or more of the example identity attestation systems 100, 400 of FIGS. 1 and 4.

At 910, an electronic device determines an identity. At 920, the electronic device uses the identity to determine whether or not a person associated with the identity meets an age threshold. If not, the flow proceeds to 930 where the electronic device provides one or more negative attestations. Otherwise, the flow proceeds to 940.

At 940, the electronic device determines whether or not the identity is associated with a payment for a transaction. If not, the flow proceeds to 930 where the electronic device provides one or more negative attestations. In some examples, the electronic device may provide a negative age attestation and negative payment attestation, either a negative age attestation or a negative payment attestation, and so on. Otherwise, the flow proceeds to 950 where the device provides a positive attestation.

In various examples, this example method 900 may be implemented as a group of interrelated software modules or components that perform various functions discussed herein. These software modules or components may be executed by one or more computing devices, such as one or more of the requestor devices 101, 401; the attestation devices 102, 402; and/or the other computing devices 106, 406 of FIGS. 1 and 4.

Although the example method 900 is illustrated and described as including particular operations performed in a particular order, it is understood that this is an example. In various implementations, various orders of the same, similar, and/or different operations may be performed without departing from the scope of the present disclosure.

For example, 950 is illustrated and described as the electronic device providing a single positive attestation. However, in various examples, the electronic device may provide multiple positive attestations. The electronic device may provide a positive age attestation and positive payment attestation, either a positive age attestation or a positive payment attestation, and so on. Various configurations are possible and contemplated without departing from the scope of the present disclosure.

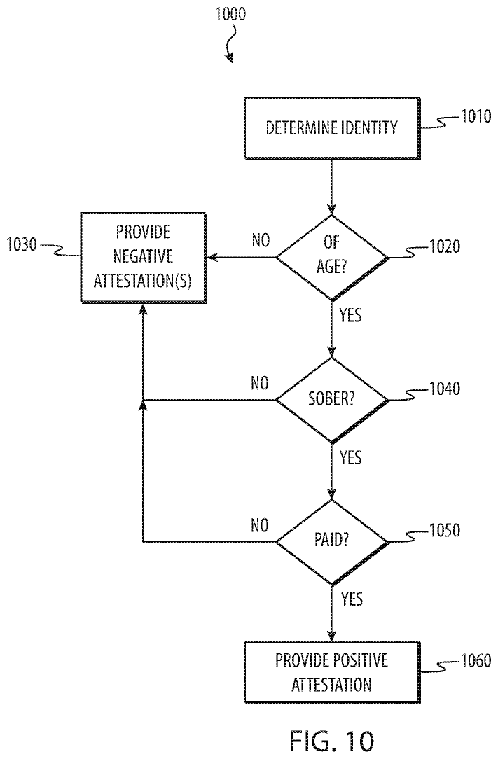

FIG. 10 depicts a flowchart illustrating an example method 1000 for operating an identity attestation system that provides age, sobriety, and payment attestations. The example method 1000 may be performed by one or more of the example identity attestation systems 100, 400 of FIGS. 1 and 4.

At 1010, an electronic device may determine an identity. At 1020, the electronic device uses the identity to determine whether or not a person associated with the identity meets an age threshold. If not, the flow proceeds to 1030 where the electronic device provides one or more negative attestations. Otherwise, the flow proceeds to 1040.

At 1040, the electronic device determines a sobriety of a person associated with the identity. If the electronic device determines the person is not sober, the flow proceeds to 1030 where the electronic device provides one or more negative attestations. Otherwise, the flow proceeds to 1050.

At 1050, the electronic device determines whether or not the identity is associated with a payment for a transaction. If not, the flow proceeds to 1030 where the electronic device provides one or more negative attestations. Otherwise, the flow proceeds to 1060 where the device provides a positive attestation.

In various examples, this example method 1000 may be implemented as a group of interrelated software modules or components that perform various functions discussed herein. These software modules or components may be executed by one or more computing devices, such as one or more of the requestor devices 101, 401; the attestation devices 102, 402; and/or the other computing devices 106, 406 of FIGS. 1 and 4.

Although the example method 1000 is illustrated and described as including particular operations performed in a particular order, it is understood that this is an example. In various implementations, various orders of the same, similar, and/or different operations may be performed without departing from the scope of the present disclosure.

For example, the method 1000 is illustrated and described as determining age, sobriety, and then payment. However, in various examples, these operations may be performed in different orders, simultaneously, and so on without departing from the scope of the present disclosure.

In some implementations, an automated sale system that uses biometrics may include at least one non-transitory storage medium that stores instructions and at least one processor. The at least one processor may execute the instructions to obtain biometric data of a person received using an automated sale device; determine an identity of the person using the biometric data; determine an age of the person using the identity; when the age of the person meets an age threshold, determine a sobriety of the person; and when the sobriety indicates the person is sober, enable vending.

In various examples, the at least one processor may determine the sobriety of the person using a same biometric data used to determine the identity. In some such examples, the biometric data may be at least one image of at least a portion of a face. In other such examples, the biometric data may be an optical scan of a finger.

In numerous examples, the at least one processor may determine the identity using first biometric data and determine the sobriety of the person using second biometric data that is different than the first biometric data. In some such examples, the first biometric data may be a phosphoresce image of a print of a finger and the second biometric data may be an optical scan of the finger.

In various examples, the at least one processor may determine the sobriety of the person using a threshold number of failed attempts to provide the biometric data.

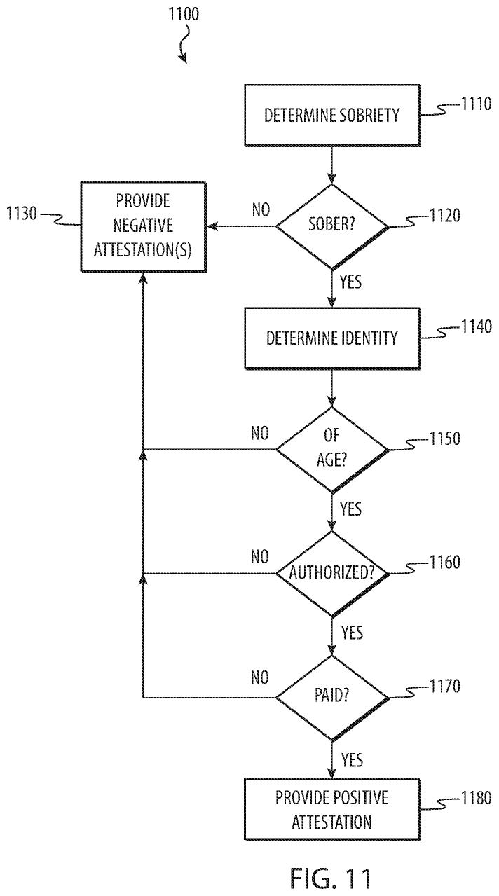

FIG. 11 depicts a flowchart illustrating an example method 1100 for operating an identity attestation system that provides age, sobriety, authorization, and payment attestations. The example method 1100 may be performed by one or more of the example identity attestation systems 100, 400 of FIGS. 1 and 4.

At 1110, an electronic device determines sobriety of a person. The flow then proceeds to 1120 where the electronic device determines whether or not the person is sober. If not, the flow proceeds to 1130 where the electronic device provides one or more negative attestations. Otherwise, the flow proceeds to 1140.

At 1140, the electronic device determines an identity of the person. The flow then proceeds to 1150 where the electronic device uses the identity to determine whether or not a person associated with the identity meets an age threshold. If not, the flow proceeds to 1130 where the electronic device provides one or more negative attestations. Otherwise, the flow proceeds to 1160.

At 1160, the electronic device determines whether or not the identity is authorized for a transaction. If not, the flow proceeds to 1130 where the electronic device provides one or more negative attestations. Otherwise, the flow proceeds to 1170.

At 1170, the electronic device determines whether or not the identity is associated with a payment for a transaction. If not, the flow proceeds to 1130 where the electronic device provides one or more negative attestations. Otherwise, the flow proceeds to 1180 where the device provides a positive attestation.

In various examples, this example method 1100 may be implemented as a group of interrelated software modules or components that perform various functions discussed herein. These software modules or components may be executed by one or more computing devices, such as one or more of the requestor devices 101, 401; the attestation devices 102, 402; and/or the other computing devices 106, 406 of FIGS. 1 and 4.

Although the example method 1100 is illustrated and described as including particular operations performed in a particular order, it is understood that this is an example. In various implementations, various orders of the same, similar, and/or different operations may be performed without departing from the scope of the present disclosure.

For example, the method 1100 is illustrated and described as separately determining sobriety and authorization. However, in some examples, sobriety may be required for authorization and may be determined as part of evaluating authorization. Various configurations are possible and contemplated without departing from the scope of the present disclosure.

In various implementations, an automated sale system that uses biometrics may include at least one non-transitory storage medium that stores instructions and at least one processor. The at least one processor may execute the instructions to obtain biometric data of a person received using an automated sale device; when the person is determined to be sober, determine an identity of the person using the biometric data; determine an age of the person using the identity; and when the age of the person meets an age threshold, enable vending via the automated sale device.

In some examples, the at least one processor may determine whether the person is sober using the biometric data. In various examples, the at least one processor may disable the vending via the automated sale device when the person is determined to not be sober. In other examples, the automated sale device may determine whether the person is sober.

In numerous examples, the at least one processor may determine payment information associated with the identity for a transaction corresponding to the vending and enable the vending via the automated sale device after processing the transaction using the payment information. In some such examples, the at least one processor may determine the payment information associated with the identity by determining the identity lacks associated payment information, using the identity to establish a credit account, associating the credit account with the identity, and using the credit account to process the transaction. In various examples, the automated sale device may perform the vending after processing a payment for a transaction corresponding to the vending.

In some implementations, an automated sale device system that uses biometrics may include at least one non-transitory storage medium that stores instructions and at least one processor. The at least one processor may execute the instructions to obtain biometric data of a person received using an automated sale device; determine a sobriety of the person using the biometric data; determine an identity of the person using the biometric data; determine an age of the person using the identity; and when the age of the person meets an age threshold and the sobriety indicates the person is sober, enable vending via the automated sale device.

In some examples, the automated sale device may vend alcohol. In various examples, the at least one processor may determine the sobriety of the person using a previous intoxication determination made within a threshold period of time. In numerous examples, the at least one processor may determine the sobriety of the person using a determination of previous alcohol purchases associated with the identity made within a threshold period of time via one or more automated sale devices.

In various examples, the at least one processor may disable the vending upon determining that the identity is unauthorized to use the automated sale device. In some such examples, the identity may be unauthorized to use the automated sale device due to previous misuse of one or more automated sale devices.

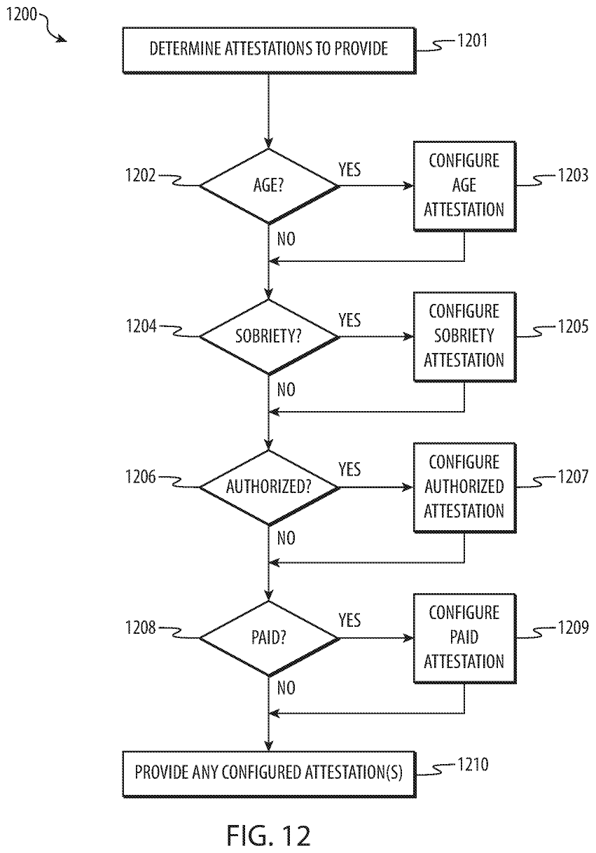

FIG. 12 depicts a flowchart illustrating an example method 1200 for operating an identity attestation system that determines and provides a variable number of attestations. The example method 1200 may be performed by one or more of the example identity attestation systems 100, 400 of FIGS. 1 and 4.

At 1201, an electronic device determines one or more attestations to evaluate and provide. In some examples, the electronic device may determine the source of a request to determine attestations to evaluate and provide, specifications in a request, and so on.

The flow proceeds to 1202 where the electronic device determines whether or not to evaluate and attest to age associated with an identity. If so, the flow proceeds to 1203 where the electronic device evaluates and configures an age attestation using the identity before the flow proceeds to 1204. Otherwise, the flow proceeds directly to 1204.

At 1204, the electronic device determines whether or not to evaluate and attest to sobriety associated with an identity. If so, the flow proceeds to 1205 where the electronic device evaluates and configures a sobriety attestation using the identity before the flow proceeds to 1206. Otherwise, the flow proceeds directly to 1206.

At 1206, the electronic device determines whether or not to evaluate and attest to authorization for a transaction associated with an identity. If so, the flow proceeds to 1207 where the electronic device evaluates and configures an authorization attestation using the identity before the flow proceeds to 1208. Otherwise, the flow proceeds directly to 1208.

At 1208, the electronic device determines whether or not to evaluate and attest to payment for the transaction associated with an identity. If so, the flow proceeds to 1209 where the electronic device evaluates and configures a payment attestation using the identity before the flow proceeds to 1210. Configuring the payment attestation may include processing payment, creating a payment account and processing payment using the created payment account, and so on. Otherwise, the flow proceeds directly to 1210.

At 1210, the electronic device provides the configured attestations. Provided attestations may include one of, multiple of, or none of an age attestation, sobriety attestation, authorization attestation, payment attestation, and/or other attestations.

In various examples, this example method 1200 may be implemented as a group of interrelated software modules or components that perform various functions discussed herein. These software modules or components may be executed by one or more computing devices, such as one or more of the requestor devices 101, 401; the attestation devices 102, 402; and/or the other computing devices 106, 406 of FIGS. 1 and 4.

Although the example method 1200 is illustrated and described as including particular operations performed in a particular order, it is understood that this is an example. In various implementations, various orders of the same, similar, and/or different operations may be performed without departing from the scope of the present disclosure.

For example, the method 1200 is illustrated and described as determining whether or not to evaluate and provide specific attestations. However, in various examples, any attestations may be evaluated and/or provided. Various configurations are possible and contemplated without departing from the scope of the present disclosure.

A number of the embodiments discussed herein involve determining sobriety and/or an intoxication level. However, it is understood that these are examples. In various implementations, the techniques discussed herein may be used in configurations that do not determine sobriety and/or intoxication levels. Some examples may be completely unconcerned with sobriety and/or intoxication levels without departing from the scope of the present disclosure.

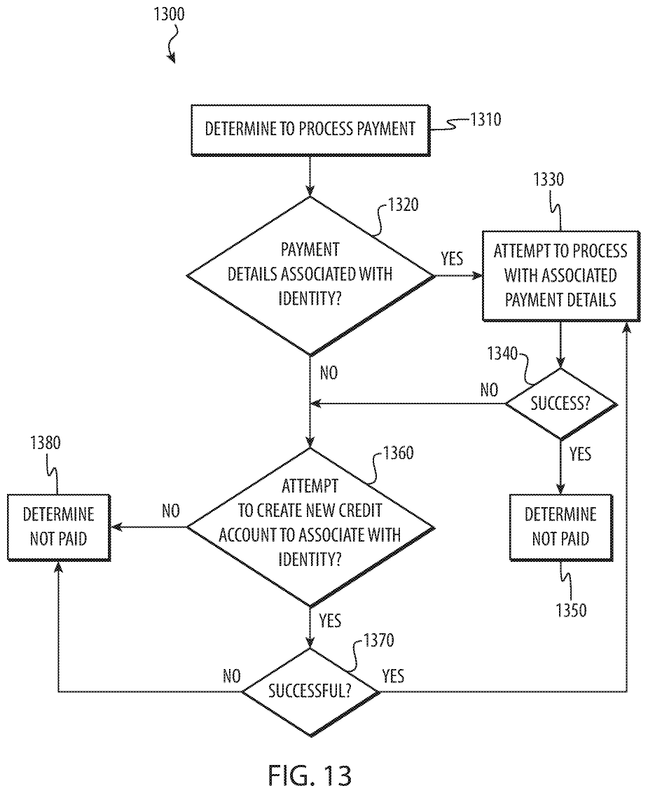

FIG. 13 depicts a flowchart illustrating an example method 1300 for operating an identity attestation system that processes payments. The example method 1300 may be performed by one or more of the example identity attestation systems 100, 400 of FIGS. 1 and 4.

At 1310, an electronic device determines to process a payment for an identity. At 1320, the electronic device determines whether or not payment details are associated with the identity. Payment details may include credit card numbers, bank account numbers, payment service account numbers, and/or any other financial details that may be used to process payment. If payment details are associated with the identity, the flow proceeds to 1330. Otherwise, the flow proceeds to 1360.

At 1330, after the electronic device determines payment details are associated with the identity, the electronic device attempts to process payment with the associated payment details. Processing payment may involve transmitting the payment details to a payment processing system or computing device. The flow then proceeds to 1340 where the electronic device determines whether or not payment processing was successful. If so, the flow proceeds to 1350 where the electronic device determines a transaction associated with the identity has been paid. Otherwise, the electronic device reevaluates and determines that the identity does not have associated payment details after all and the flow proceeds to 1360.

At 1360, after the electronic device determines payment details are not associated with the identity, the electronic device attempts to create a new credit account or other payment details to associate with the identity. The electronic device may attempt to create such a credit account using various biographic information that may be associated with the identity (such as name, address, social security number, income, and so on). The flow then proceeds to 1370 where the electronic device determines whether the attempt is successful. If so, the flow proceeds to 1330 where the electronic device associates the credit account with the identity as payment details and attempts to process payment using the newly associated payment details. Various other actions may also be performed, such as signaling a computing device to mail a credit card or other account details to an address associated with the identity. Otherwise, the flow proceeds to 1380 where the electronic device determines that the transaction is not paid.

Although the above illustrates and describes determining that the transaction is not paid if payment details are not associated, payment processing is not successful, and a credit account cannot be created, it is understood that this is an example. In some implementations, the electronic device may include a payment accepting device such as a credit card reader, a cash bill and/or coin accepting device, and so on. In such implementations, one or more of the above operations may prompt for and/or obtain payment for the transaction using the payment accepting device if payment details are not associated, payment processing is not successful, and/or a credit account cannot be created. Various configurations are possible and contemplated without departing from the scope of the present disclosure.

In various examples, this example method 1300 may be implemented as a group of interrelated software modules or components that perform various functions discussed herein. These software modules or components may be executed by one or more computing devices, such as one or more of the requestor devices 101, 401; the attestation devices 102, 402; and/or the other computing devices 106, 406 of FIGS. 1 and 4.

Although the example method 1300 is illustrated and described as including particular operations performed in a particular order, it is understood that this is an example. In various implementations, various orders of the same, similar, and/or different operations may be performed without departing from the scope of the present disclosure.

For example, in various examples, the electronic device may not create a new credit account if payment details are not associated with the identity. Various configurations are possible and contemplated without departing from the scope of the present disclosure.

The various attestation systems, biometric or other identity systems, automated sale devices, vending machines and other devices discussed above may be subject to a variety of different requirements. These may be laws, regulations, codes, and so on imposed by various local, state, federal, regulatory agencies, and/or other entities. Such systems and devices may comply with such requirements related to sales or leases of goods or services (such as alcohol, prescription or other medication, food, and so on), storage of biometric or other data or determinations related to identity, and so on. Such requirements may be specific to where a system or device operates, and may change at various times.

In order to maintain compliance with such requirements, such systems or devices may communicate in real time with one or more computing devices to access one or more databases where such requirements are stored, determine relevant requirement(s), and configure one or more decision points (any operating procedure or decision that the systems or devices evaluate to perform actions based thereon) that such systems or devices use to operate based on the relevant requirement(s).

This may be possible to be automated due to the availability of electronic databases where such requirements are stored and updated, as well as the hierarchical codification of such requirements. For example, state laws may be codified in a hierarchical structure numerically with numbered sections and subsections. This may allow an electronic device to access a state law database in real time, determine real time current state laws regarding alcohol sales according to the numerical sections and subsections where such alcohol sales laws are recorded, determine the relevant laws related to alcohol sales, and configure any decision points related to alcohol sales (such as age required, sobriety level required, time before end of a sporting event that alcohol sales are allowed, types of alcohol allowed for sale, and so on) in order to maintain compliance with the relevant requirements in real time specifically according to where the electronic device operates. The electronic device may perform similarly with respect to any legal or other requirements regarding data storage, biometrics, privacy, and so on.

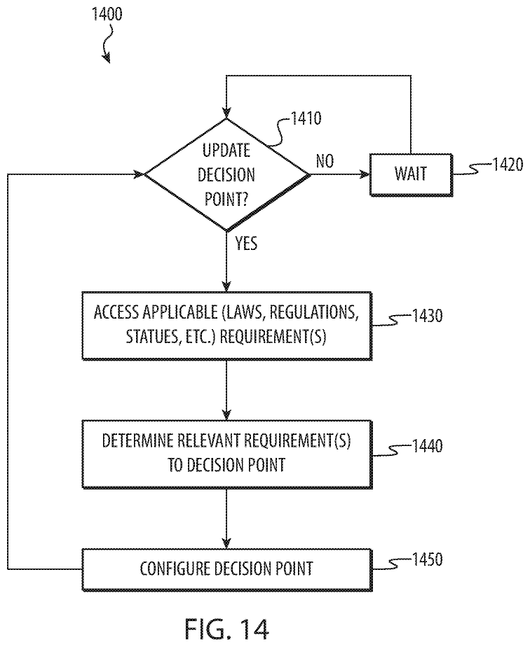

FIG. 14 depicts a flowchart illustrating an example method 1400 for operating an identity attestation system that configures decision points using real time obtained legal requirements. The example method 1400 may be performed by one or more of the example identity attestation systems 100, 400 of FIGS. 1 and 4.

At 1410, an electronic device determines whether or not to update one or more decision points for compliance with real time current requirements. If not, the electronic device waits a period of time (such as one day) at 1420 before the flow returns to 1410 and the electronic device again determines whether or not to update. Otherwise, the flow proceeds to 1430.

At 1430, the electronic device accesses applicable requirements. The applicable requirements may be state, local, federal, municipal, and/or other laws, regulations, statutes, and so on. Next, the flow proceeds to 1440 where the electronic device determines which requirements are relevant to the decision point. The flow then proceeds to 1450 where the electronic device configures the decision point according to the relevant requirement.

Subsequently, the flow returns to 1410 and the electronic device again determines whether or not to update.

For example, the electronic device may update decision points related to age for alcohol sales. The electronic device may determine that state laws have increased the age for alcohol sales from 21 to 22. As such, the electronic device may update any alcohol age decision points to evaluate age 22 instead of age 21.

By way of another example, the electronic device may update data storage decision points. Local law may have previously stated that biometric data must be stored. As such, the electronic device may be configured with decision points relating to biometric data storage specifying to store biometric data. However, local laws may change to specify that biometric data may not be stored. As such, the electronic device may reconfigure the decision points in real time so that biometric data is not stored.

In various examples, this example method 1400 may be implemented as a group of interrelated software modules or components that perform various functions discussed herein. These software modules or components may be executed by one or more computing devices, such as one or more of the requestor devices 101, 401; the attestation devices 102, 402; and/or the other computing devices 106, 406 of FIGS. 1 and 4.

Although the example method 1400 is illustrated and described as including particular operations performed in a particular order, it is understood that this is an example. In various implementations, various orders of the same, similar, and/or different operations may be performed without departing from the scope of the present disclosure.

For example, the method 1400 is illustrated and described as accessing applicable requirements and then determining which are relevant. However, in some examples, the electronic device may only access relevant requirements. As such, multiple steps may not be used.

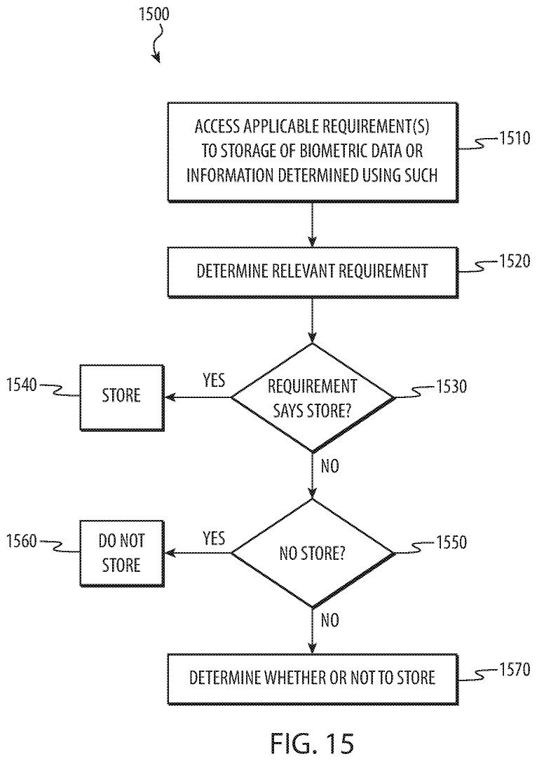

FIG. 15 depicts a flowchart illustrating an example method 1500 for operating an identity attestation system that configures data storage relating to identity using real time obtained legal requirements. The example method 1500 may be performed by one or more of the example identity attestation systems 100, 400 of FIGS. 1 and 4.

At 1510, an electronic device accesses applicable requirements to storage of biometric data or information determined using such. The flow may proceed to 1520 where the electronic device determines which requirements are relevant. Next, the flow may proceed to 1530 where the electronic device determines whether or not the requirements say to store such data. If so, the flow proceeds to 1540 where the electronic device configures itself to store such data. Otherwise, the flow proceeds to 1550.

At 1550, after the electronic device determines that the requirements do not say to store such data, the electronic device determines whether or not the requirements require such data not to be stored. If so, the flow proceeds to 1560 where the electronic device configures itself not to store such data.

Otherwise, the flow proceeds to 1570 where the electronic device determines that the requirements allow but do not require storage and the electronic device itself determines whether or not to store. For example, some electronic devices may store unless prohibited while others may not store unless required. Still others may store some data if allowed but may not store other data even if allowed. Various configurations are possible and contemplated.

In various examples, this example method 1500 may be implemented as a group of interrelated software modules or components that perform various functions discussed herein. These software modules or components may be executed by one or more computing devices, such as one or more of the requestor devices 101, 401; the attestation devices 102, 402; and/or the other computing devices 106, 406 of FIGS. 1 and 4.

Although the example method 1500 is illustrated and described as including particular operations performed in a particular order, it is understood that this is an example. In various implementations, various orders of the same, similar, and/or different operations may be performed without departing from the scope of the present disclosure.

For example, the method 1500 is illustrated and described as determining whether storage is required, then determining if storage is prohibited, and then evaluating whether or not to store if storage is neither required nor prohibited. However, in some implementations, the electronic device may evaluate whether data storage is required or prohibited and configure accordingly without other determinations. Various configurations are possible and contemplated without departing from the scope of the present disclosure.

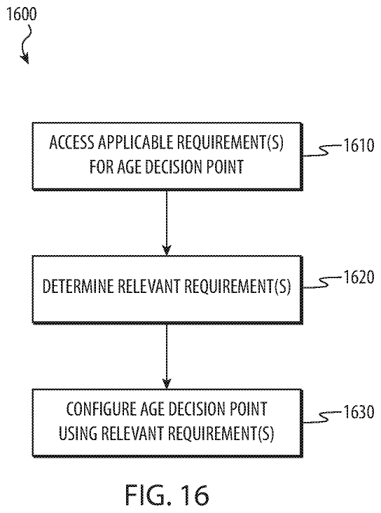

FIG. 16 depicts a flowchart illustrating an example method 1600 for operating an identity attestation system that configures an age attestation decision point using real time obtained legal requirements. The example method 1600 may be performed by one or more of the example identity attestation systems 100, 400 of FIGS. 1 and 4.

At 1610, an electronic device accesses applicable requirements for an age decision point. The flow then proceeds to 1620 where the electronic device determines the requirements relevant to the specific age decision point. Next, at 1630 the electronic device configures the specific age decision point using the relevant requirement.

For example, a municipality may have a requirement that specifies that people between the ages of 21-30 can only purchase 3.2% alcohol by weight beer at sporting events. An attestation system may receive an attestation request from a beer automated sale device at a sporting event in the municipality. The attestation system may access the laws for the municipality and configure its age decision point to only allow the beer automated sale device to vend 3.2% alcohol by weight beer to people determined to be between 21-30 years of age.

In various examples, this example method 1600 may be implemented as a group of interrelated software modules or components that perform various functions discussed herein. These software modules or components may be executed by one or more computing devices, such as one or more of the requestor devices 101, 401; the attestation devices 102, 402; and/or the other computing devices 106, 406 of FIGS. 1 and 4.

Although the example method 1600 is illustrated and described as including particular operations performed in a particular order, it is understood that this is an example. In various implementations, various orders of the same, similar, and/or different operations may be performed without departing from the scope of the present disclosure.

For example, the method 1600 is illustrated and described as separate, linearly performed operations. However, in some implementations, one or more of these operations may be combined and/or performed simultaneously, substantially simultaneously, and/or in different orders. Various configurations are possible and contemplated without departing from the scope of the present disclosure.

Various embodiments discussed above reference determining applicable legal and/or other requirements and configuring electronic devices based upon such determinations. In various implementations, electronic device may use various techniques and/or components to determine their locations and/or that their locations have changed in order to determine such applicable legal and/or other requirements and configure themselves accordingly.

For example, electronic devices may include global positioning system components or other location components that they may use to determine their location and the applicable legal and/or other requirements that correspond to that location. By way of another example, electronic device may communicate using one or more wired and/or wireless communication networks and may determine their location using the network and/or by communicating with one or more devices over the network.

Regardless of the mechanism by which electronic device determine their location, electronic device may determine their location and/or that their location has changed, obtain applicable legal and/or other requirements according to the determined location and/or changed location, and configure themselves according to the obtained applicable legal and/or other requirements for the location and/or changed location. For example, an automated sale device may be used by a circus that travels to different locations across a country and/or the world. When first operated, the automated sale device may determine an initial location (initial as the automated sale device had not previously determined its location), obtain applicable legal and/or other requirements according to the determined location, and configure itself accordingly. Subsequently, when the automated sale device is moved as part of the circus traveling, the automated sale device may determine its updated location, obtain applicable legal and/or other requirements according to the determined updated location, and reconfigure itself accordingly.

In other examples, electronic devices may be informed of their location and/or be supplied applicable legal and/or other requirements for their location by systems connected to the electronic devices. For example, automated sale devices may be located on cruise ships and a system may determine locations of the automated sale devices (such as by detecting where the automated sale devices are located, consulting cruise routes for where vending machines are to be located at particular times, and so on) and may push the locations and/or the applicable legal and/or other requirements to the automated sale devices. Such systems may also update the automated sale devices for changed locations. Various configurations are possible and contemplated without departing from the scope of the present disclosure.

The present disclosure describes a number of technologies and systems operating together in various combinations. However, it is understood that these are examples. Various attestation systems, biometric or other vending machines, automated sale devices, identification or other identity systems, biometric identification systems, devices that adjust decision points in real time according to relevant requirements, and so on may be utilized separately, in different contexts, and/or in different combinations than those specifically illustrated and described without departing from the scope of the present disclosure. Various configurations are possible and contemplated.

As described above and illustrated in the accompanying figures, the present disclosure relates to automated sale devices that use biometrics. Automated sale devices may be used in systems that determine identity and provide one or more attestations that are used to control vending. Such attestations may link biometrics and sobriety determinations, such as in systems where automated sale devices are used to vend alcohol or prescription medications. In some implementations, such automated sale devices may be used in systems that configure operations in real time according to applicable legal requirements. These various technologies allow automated sale device, vending machines, and/or the systems in which they operate to perform functions not previously possible as well as to function more efficiently using fewer resources.

The present disclosure recognizes that biometric and/or other personal data is owned by the person from whom such biometric and/or other personal data is derived. This data can be used to the benefit of those people. For example, biometric data may be used to conveniently and reliably identify and/or authenticate the identity of people, access securely stored financial and/or other information associated with the biometric data, and so on. This may allow people to avoid repeatedly providing physical identification and/or other information.

The present disclosure further recognizes that the entities who collect, analyze, store, and/or otherwise use such biometric and and/or other personal data should comply with well-established privacy policies and/or privacy practices. Particularly, such entities should implement and consistently use privacy policies and practices that are generally recognized as meeting or exceeding industry or governmental requirements for maintaining security and privately maintaining biometric and/or other personal data, including the use of encryption and security methods that meets or exceeds industry or government standards. For example, biometric and/or other personal data should be collected for legitimate and reasonable uses and not shared or sold outside of those legitimate uses. Further, such collection should occur only after receiving the informed consent. Additionally, such entities should take any needed steps for safeguarding and securing access to such biometric and/or other personal data and ensuring that others with access to the biometric and/or other personal data adhere to the same privacy policies and practices. Further, such entities should certify their adherence to widely accepted privacy policies and practices by subjecting themselves to appropriate third party evaluation.

Additionally, the present disclosure recognizes that people may block the use of, storage of, and/or access to biometric and/or other personal data. Entities who typically collect, analyze, store, and/or otherwise use such biometric and/or other personal data should implement and consistently prevent any collection, analysis, storage, and/or other use of any biometric and/or other personal data blocked by the person from whom such biometric and/or other personal data is derived.

Although particular methods involving particular operations have been illustrated and described, it is understood that these are examples. In various implementations, various arrangements of the same, similar, and/or different operations may be performed without departing from the scope of the present disclosure. Various configurations are possible and contemplated.

Aspects of the present disclosure may be performed by one or more devices, such as one or more computing devices, that may be configured as part of a system. For example, one or more computing devices that perform one or more aspects of this disclosure may be part of a cloud computing system, cooperative computing arrangement, and so on. Such devices may include one or more processors or other controllers or processing units, one or more non-transitory storage media (which may take the form of, but is not limited to, a magnetic storage medium; optical storage medium; magneto-optical storage medium; read only memory; random access memory; erasable programmable memory; flash memory; and so on), and/or other components. The processing unit may execute one or more instructions stored in the non-transitory storage medium to perform one or more processes that utilize one or more of the techniques disclosed herein.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. An automated biometric pharmacy vending system, comprising:
a non-transitory storage medium that stores instructions;
a dispensing mechanism; and
a processor that executes the instructions to:
obtain a digital representation of a biometric of a person;
determine an identity of the person using the digital representation of the biometric;
determine a pickup order associated with the identity;
determine that the pickup order includes a prescription item; and
upon verifying that a valid prescription for the prescription item is associated with the identity, enable the dispensing mechanism to provide the pickup order.

2. The system of claim 1, wherein the pickup order includes a non-prescription item.

3. The system of claim 1, wherein:
the pickup order includes a medical product that is subject to a regulation regarding an amount of purchase allowed within a period of time; and
the processor determines that purchases less than the amount within the period of time are associated with the identity.

4. The system of claim 1, wherein:
the pickup order includes a product restricted to a threshold age; and
the processor determines the identity is associated with an age that is at least the threshold age.

5. The system of claim 1, wherein the processor processes a payment for the pickup order prior to enabling the dispensing mechanism to provide the pickup order.

6. The system of claim 5, wherein the processor processes the payment using payment details associated with the identity.

7. The system of claim 1, wherein:
the prescription item is a first prescription item;
the person is a first person; and
the processor:
determines that the pickup order includes a second prescription item associated with a second person; and
determines information associated with the identity indicates that the first person is authorized to pick up the second prescription item for the second person prior to enabling the dispensing mechanism to provide the pickup order.

8. An automated biometric pharmacy vending system, comprising:
a non-transitory storage medium that stores instructions;
a dispensing mechanism; and
a processor that executes the instructions to:
obtain a digital representation of a biometric of a person;
determine an identity of the person using the digital representation of the biometric;
determine a pickup order associated with the identity;
determine that insurance coverage is associated with the identity; and
upon at least partially processing a payment using the insurance coverage, enable the dispensing mechanism to provide the pickup order.

9. The system of claim 8, wherein the processor:
determines that the insurance coverage is applicable to a portion of the pickup order; and
uses the insurance coverage to at least partially process the payment for the portion of the pickup order.

10. The system of claim 8, wherein:
the payment is a first payment;
the first payment partially pays for a cost of the pickup order; and
the processor processes a second payment for a remainder of the cost of the pickup order prior to enabling vending of the pickup order.

11. The system of claim 8, wherein the insurance coverage discounts the pickup order.

12. The system of claim 8, wherein the processor:
determines that the identity qualifies for a discounted pricing on at least a portion of the pickup order; and
at least partially processes the payment using the discounted pricing.

13. The system of claim 8, wherein the processor verifies a prescription for an item in the pickup order prior to enabling vending.

14. The system of claim 8, wherein:
the payment is a first payment;
the first payment partially pays for a cost of the pickup order; and
the processor processes a second payment for a remainder of the cost of the pickup order using a loyalty or rewards program associated with the identity prior to enabling vending of the pickup order.

15. An automated biometric pharmacy vending system, comprising:
a non-transitory storage medium that stores instructions;
a dispensing mechanism; and
a processor that executes the instructions to:
obtain a digital representation of a biometric of a person;
determine an identity of the person using the digital representation of the biometric;
determine a pickup order associated with the identity;
determine that the identity qualifies for a discounted pricing on at least a portion of the pickup order; and
upon at least partially processing a payment for the at least the portion of the pickup order using the discounted pricing, enable the dispensing mechanism to provide the pickup order.

16. The system of claim 15, wherein the processor determines that the identity qualifies for the discounted pricing on the at least the portion of the pickup order by communicating with a device associated with a manufacturer of a product in the at least the portion of the pickup order.

17. The system of claim 15, wherein the processor determines that the identity qualifies for the discounted pricing on the at least the portion of the pickup order by communicating with a device associated with a governmental assistance program.

18. The system of claim 15, wherein the processor determines that the identity qualifies for the discounted pricing on the at least the portion of the pickup order by communicating with a device associated with a charity organization.

19. The system of claim 15, wherein the processor determines that the identity qualifies for the discounted pricing on the at least the portion of the pickup order by using information associated with the identity to determine that the person does not have medication insurance coverage.

20. The system of claim 15, wherein the processor determines that the identity qualifies for the discounted pricing on the at least the portion of the pickup order by using information associated with the identity to determine that the person has an income less than a threshold.
